(19) United States
(12) Patent Application Publication
(10) Pub. No.: US 2020/0331654 A1
(43) Pub. Date: Oct. 22, 2020

(54) MOUNTABLE CONTAINER

(71) Applicant: Carl Reid, Charlotte, NC (US)

(72) Inventor: Carl Reid, Charlotte, NC (US)

(21) Appl. No.: 16/388,633

(22) Filed: Apr. 18, 2019

(51) Int. Cl. B65D 5/42; F16M 13/02; A47G 7/04; E04F 11/18; B25H 3/02

(52) U.S. Cl. CPC B65D 5/4208; F16M 13/022; A47G 7/044; E04F 2011/188; B25H 3/02; B65D 2303/00; E04F 11/18

(57) ABSTRACT

Provided is a mountable container including a body portion, defined by an exterior wall, at least one partition disposed within a general interior region of the body portion, wherein the at least one partition defines a first interior region and a second interior region, at least one insert disposed within the first interior region, the insert having a ramped surface with respect to a flat bottom surface of the first interior region, wherein, when the body portion is mounted to a sloped structure at a slope corresponding to a slope of the sloped structure, the ramped surface of the insert is flat with respect to a ground surface. An associated method is also provided.

### CROSS-REFERENCE TO RELATED APPLICATIONS

This application claims priority to U.S. Provisional Application No. 62/659,809, filed Apr. 18, 2019, and entitled “Mountable Container.”

### FIELD OF TECHNOLOGY

following relates to a mountable container, and more specifically to embodiments of a container that can be mounted to a sloped structure while maintaining contents within the container relatively level.

### BACKGROUND

Attaching level objects to sloped structures can interfere with the levelness of contents places within the object. For example, if an object is mounted to a sloped object, such as stairs, contents within the object may be urged to one side or the other, depending on the incline. When the contents are displayed in the object attached to the sloped structure, the appearance may be aesthetically unpleasant.

Thus, a need exists for a container that can be mounted to a sloped structure while maintaining contents within the container relatively level.

### SUMMARY

A first aspect relates to a mountable container including a body portion, defined by an exterior wall, at least one partition disposed within a general interior region of the body portion, wherein the at least one partition defines a first interior region and a second interior region, at least one insert disposed within the first interior region, the insert having a ramped surface with respect to a flat bottom surface of the first interior region, wherein, when the body portion is mounted to a sloped structure at a slope corresponding to a slope of the sloped structure, the ramped surface of the insert is flat with respect to a ground surface

A second aspect relates to mountable container that can be mounted to a sloped structure while maintaining contents within the container relatively level.

A third aspect relates to a method for maintaining a flat display surface within a sloped container, the method comprising: disposing a ramped insert into an interior region of the sloped container.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a perspective, top view of a container, in accordance with embodiments of the present invention;

FIG. 2 depicts a side view of the container in a level orientation, in accordance with embodiments of the present invention;

FIG. 3 depicts top view of the container, in accordance with embodiments of the present invention;

FIG. 4 depicts a cross-sectional view along line A-A of FIG. 3, in accordance with embodiments of the present invention;

FIG. 5 is a perspective, bottom view of the container, in accordance with embodiments of the present invention;

FIG. 6 depicts a cross-sectional view along line A-A of FIG. 3 in an operable configuration, in accordance with embodiments of the present invention;

FIG. 7 depicts a perspective view of an insert insertable into the container, in accordance with embodiments of the present invention;

FIG. 8 depicts a side view of the insert, in accordance with embodiments of the present invention;

FIG. 9 depicts a front view of the insert, in accordance with embodiments of the present invention;

FIG. 10 depicts a rear view of the insert, in accordance with embodiments of the present invention;

FIG. 11 depicts a bottom view of the insert, in accordance with embodiments of the present invention;

FIG. 12 depicts a bottom, perspective view of a mounting element for the container, in accordance with embodiments of the present invention;

FIG. 13 depicts a top, perspective view of the mounting element, in accordance with embodiments of the present invention;

FIG. 14 depicts a side view of the mounting element, in accordance with embodiments of the present invention;

FIG. 15 depicts a view of the container mounted to a sloped structure, in accordance with embodiments of the present invention;

FIG. 16a depicts a first installation step, in accordance with embodiments of the present invention;

FIG. 16b depicts a second installation step, in accordance with embodiments of the present invention;

FIG. 16c depicts a third installation step, in accordance with embodiments of the present invention;

FIG. 16d depicts a fourth installation step, in accordance with embodiments of the present invention;

FIG. 16e depicts a fifth installation step, in accordance with embodiments of the present invention;

FIG. 16f depicts a sixth installation step, in accordance with embodiments of the present invention;

FIG. 16g depicts a seventh installation step, in accordance with embodiments of the present invention;

FIG. 16h depicts an eighth installation step, in accordance with embodiments of the present invention; and

FIG. 16i depicts a ninth installation step, in accordance with embodiments of the present invention.

### DETAILED DESCRIPTION

A detailed description of the hereinafter described embodiments of the disclosed apparatus, method, and system are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

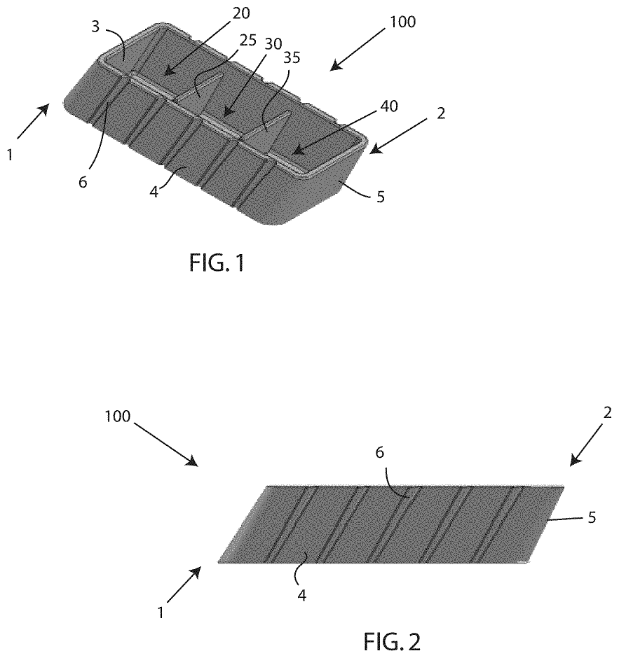

Referring now to the drawings, FIGS. 1-3 depict a container 100, in accordance with embodiments of the present invention. Embodiments of the container 100 may be a container, a storage container, a storage box, a display case, a display box, a contents holder, a basket, a receptacle, and the like. Embodiments of the container 100 may be configured to mount, attach, secure, or otherwise couple to a structure, such as a sloped structure. In an exemplary embodiment, the container 100 may be a planter, a flower box, a plant holder, and the like. For instance, embodiments of the container 100 may store, hold, receive, display, accept, etc. plant contents therein. Plant contents contained within the container 100 may be plants, flowers, soil, seeds, vegetables, herbs, and the like. In other embodiments, the container 100 may store, hold, receive, display, accept, etc. various types of contents, such as tools, materials, books, beverages, kick-knacks, or any tangible items that can fit within the container 100. Further, embodiments of the container 100 may be mounted to a sloped structure in a sloped orientation, while maintaining contents within the container relatively level or parallel with a ground surface.

Embodiments of the container 100 may include a first end 1, a second end 2, and an inner surface 4. A shape or general body structure of the container 100 may be defined by an exterior wall 5. The exterior wall 5 may form a generally rectangular shaped container 100, having rounded or squared edges. A plurality of grooves 6 may be disposed on the exterior wall 5 at various locations along the exterior wall 5. Embodiments of the grooves 6 may be grooves, channels, voids, openings, slots, etc., which can be spaced a distance apart from each other. For instance, embodiments of the grooves 6 may be spaces apart from each other a distance that corresponds to a standard distance between spindles of a stair case. In one embodiment, the grooves 6 may be sized and dimensioned to snugly accept a spindle of a stair case for added stability when mounted to a sloped structure, such as a stair case. For example, a spindle or other vertical structural element of a sloped structure may be received within the grooves 6 such via an interference fit to enhance a connection between the container 100 and the sloped structure. In other embodiments, the grooves 6 may not be used to enhance the connection between the container 100 and the sloped structure, relying solely on a mounting element as described infra.

Moreover, embodiments of the container 100 may have a general interior region for receiving contents, such as soil, seeds, plants, etc. The general interior region may be a region, area, space, void, etc. between a bottom surface of the container 100 and the exterior wall 5. The interior region may be partitioned into multiple interior regions with one or more partitions. For instance, embodiments of the container 100 may include a first partition 25 and a second partition 35, which may partition or otherwise divide the general interior region of the container 100 into a first interior region 20, a second interior region 30, and a third interior region 40. Embodiments of the container 100 may include more than two or less than two partitions to form more than three or less than three separate interior regions. Additionally, the partitions 25, 35 may be spaced apart from each other to create equal or non-equal sized interior regions 20, 30, 40. Embodiments of the partitions 25, 35 may be a partition, a divider, a wall, and the like. Embodiments of the interior regions 20, 30, 40 may be an interior region, a cavity, space, a receiving area, a receptacle, a storage area, and the like.

FIG. 2 depicts a side view of the container 100 in a level orientation, in accordance with embodiments of the present invention. In a level orientation, the partitions 25, 35 may be oblique or non-parallel to a ground surface. Similarly, the grooves 6 may be oblique or non-parallel to the ground surface in the level orientation depicted in FIG. 2. FIG. 4 shows the partitions 25, 35 may be non-parallel to a ground surface in a level orientation. For operable mounting to a sloped structure, the container 100 may be rotated such that the partitions 25, 35 become perpendicular or substantially perpendicular to the ground surface as described in greater detail infra.

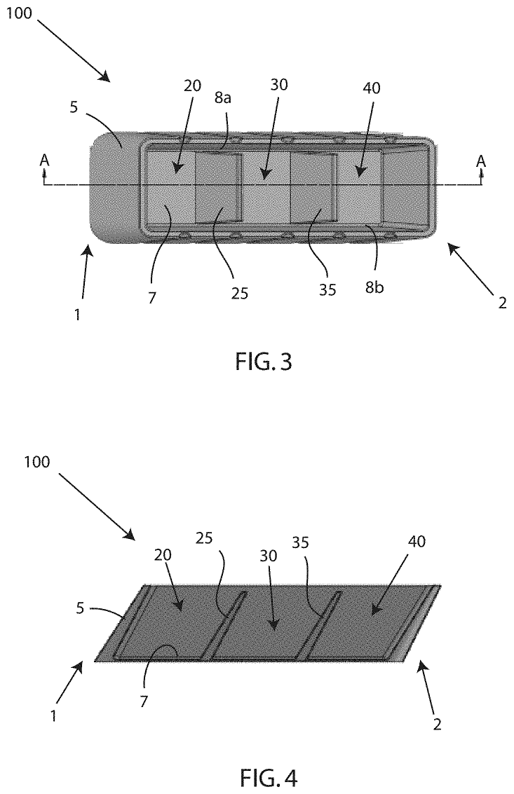

Referring back to FIG. 3, which depicts top view of the container 100 in accordance with embodiments of the present invention. Embodiments of the container 100 may have a bottom surface 7. The bottom surface 7 of the container 100 may be level or parallel with a flat, ground surface, in a level orientation, as shown in FIG. 4. Each interior region 20, 30, 40 may have a bottom surface 7 for supporting contents placed within the container 100. Furthermore, embodiments of the container 100 may include flow channels 8a, 8b extending lengthwise from the first end 1 towards the second end 2 of the container 100. Embodiments of the flow channels 8a, 8b may be a flow path, a channel, a groove, a slot, a drain, an irrigation channel, or other fluidic pathway. The flow channels 8a, 8b may allow water or other flowable materials to flow therethrough to fluidically connect the interior regions 20, 30, 40. For example, water entering or accumulating within the container 100 may flow across the bottom surface 7 of the container 100 and into the flow channels 8a, 8b for displacement to another section of the container 100. The flow channels 8a, 8b may be disposed along or otherwise proximate an edge formed between the bottom surface 7 and the inner surface 3 of the exterior wall 5. As shown in FIGS. 3 and 5, the flow channels 8a, 8b may pass between a space, gap, etc. between the partitions 25, 35 and the exterior wall 5 to connect the interior regions 20, 30, 40 of the container 100.

Furthermore, as shown in FIG. 5, a gap g may exist between the general receiving structure of the container 100 and the exterior wall 5. The gap g may permit the constructions of the grooves 6 along the exterior wall 5, wherein portions of the exterior wall 5 protrude inwardly towards the general interior of the container 100. FIG. 5 also shows one method for manufacturing the partitions 25, 35, in which the partitions 25, 35 are extruded to form a wall within the general interior of the container 100, such that the entire container 100 may be produced as a single component. In other words, the container 100 may be entirely structurally integral. In an exemplary embodiment, the container 100 may be comprised of one or more plastics. Other manufacturing methods and materials may be used to manufacture the container 100.

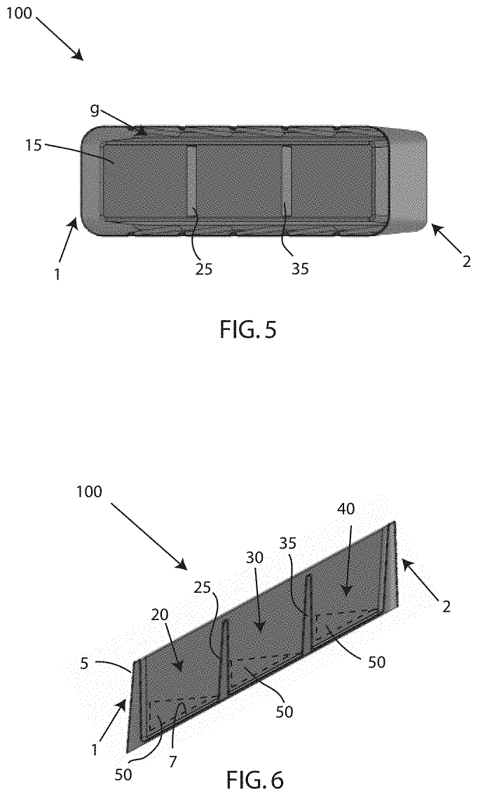

Referring now to FIG. 6, which depicts a cross-sectional view along line A-A of FIG. 3 in an operable configuration, in accordance with embodiments of the present invention. The operable configuration of the container may be a sloped, inclined, declined, or ramped orientation. The sloped operable configuration may correspond to a slope of a sloped structure to which the container 100 is to be mounted. In the operable configuration, embodiments of the partitions 25, 35 may be perpendicular or substantially perpendicular to a ground surface, while the general body of the container 100 is sloped, inclined, declined, or ramped. If contents were to be placed within the container 100 in this configuration, the contents would not likely be level, and likely be urged towards the first end 1 due to gravity. This may result in an aesthetically displeasing display of contents placed therein, or generally disorganization of objects placed therein. However, embodiments of the container 100 may include inserts 50 that can be inserted into the interior regions 20, 30, 40 to effectuate a level or flat surface, within a generally sloped container 100.

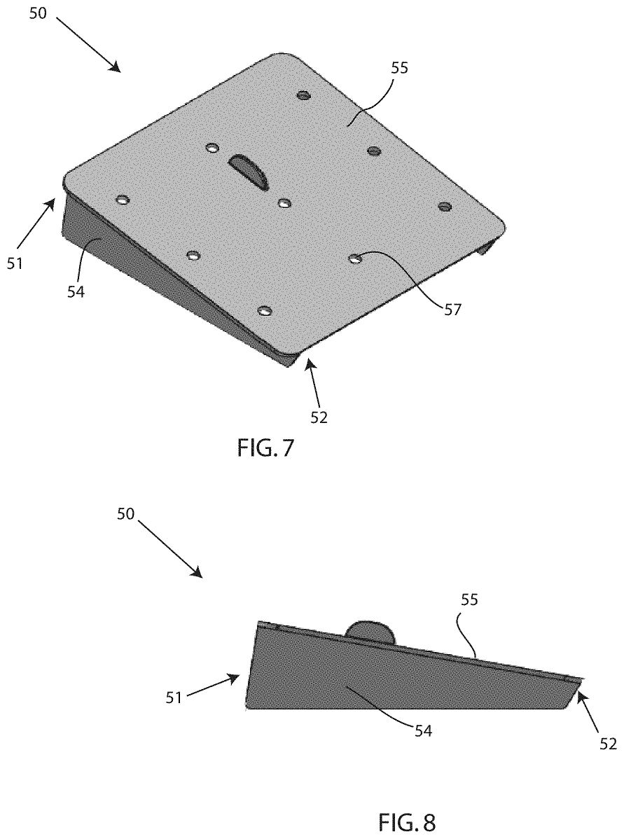

FIGS. 7-11 depict embodiments of insert 50, in accordance with embodiments of the present invention. Embodiments of insert 50 may be an insert, a wedge element, a leveling element, and the like. Embodiments of the insert 50 may include a ramped surface 55. The ramped surface 55 may be ramped and supported by two feet 54 extending from a first end 51 of the insert 50 to a second opposing end 52 of the insert 50. The feet 54 may be a tapered wall structure, having a height greater proximate the first end 51 than a height proximate the second end 52. In an operable configuration, inserts 50 may be inserted or otherwise received within the interior regions 20, 30, 40, such that the first end 51 of the insert 50 is placed closer to the first end 1 of the container 100, when the first end 1 of the container 1 is lower elevationally than the second end 2. Due to the tapered structure of the feet 54 of the insert 50, the ramped surface 55 may actually be flat or level with respect to a ground surface when the container 100 is mounted to the sloped structure 100 in a correspondingly sloped orientation. Moreover, contents may be placed directly onto the ramped surface 55 (which is level in the operable configuration). The surface 55 may include a projection, tab, or void to facilitate lifting the insert 50 out of the container 100. Such projection or tab may be a hook, ring, circle, semicircle, rod, depression, hole, cylinder, screw, string, chain, or disc. The surface 55 may include one or more openings 57 for draining water or other flowable materials. For instance, if the container 100 is mounted outdoors and collects rain water, or mounted indoors or outdoors and a user waters the contents placed on the surface 55, water may pass through the openings 55 and flow to the bottom surface 7 of the container 100. The water may then flow to the flow channels 8a, 8b to flow from one interior region to the next, depending on the gravitational force acting upon the container 100. The bottom surface 7 may also have drain holes to allow water to flow out of the container 100 into the external environment. Such an arrangement may be beneficial when container is placed in an area which experiences excessive water entering container 100.

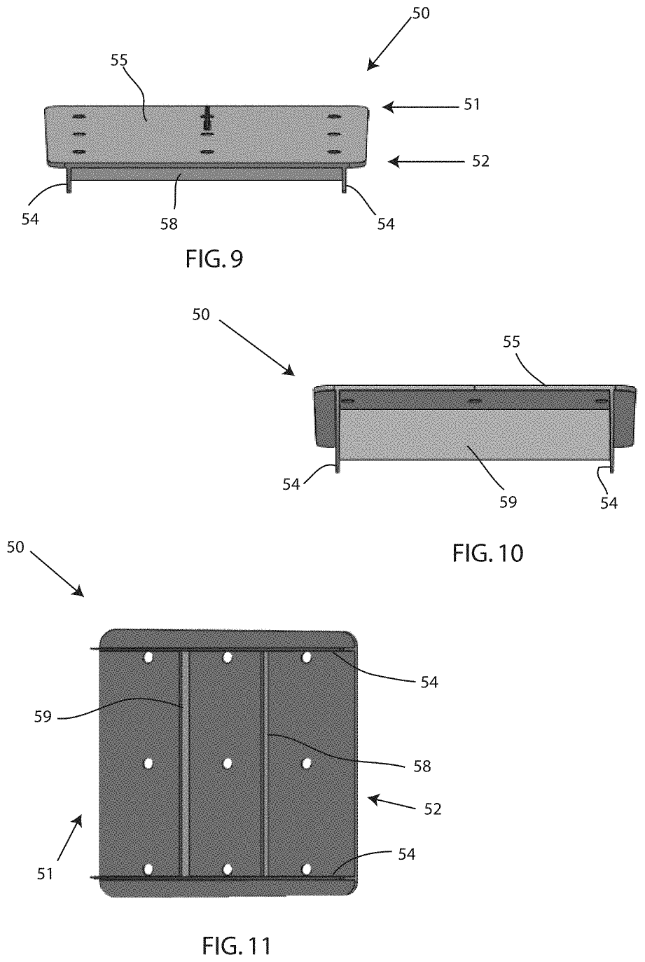

FIGS. 9-11 depict supporting structure 58, 59 which may interconnect the two feet 54 of the insert 50. The first supporting structure 58 may have a smaller height than a height of a second supporting structure 59. The supporting structure 58, 59 may provide additional structural integrity to the insert 50, which may experience loads from contents placed onto the ramped surface 55.

In alternative embodiments, the inserts 50 may be permanently disposed within the container 100 using one or more fasteners, adhesive, etc. In addition, the insert 50 may alternatively not be configured to be removed or inserted, but rather may be formed structurally integral with the general body structure of the container 100 during a manufacturing process.

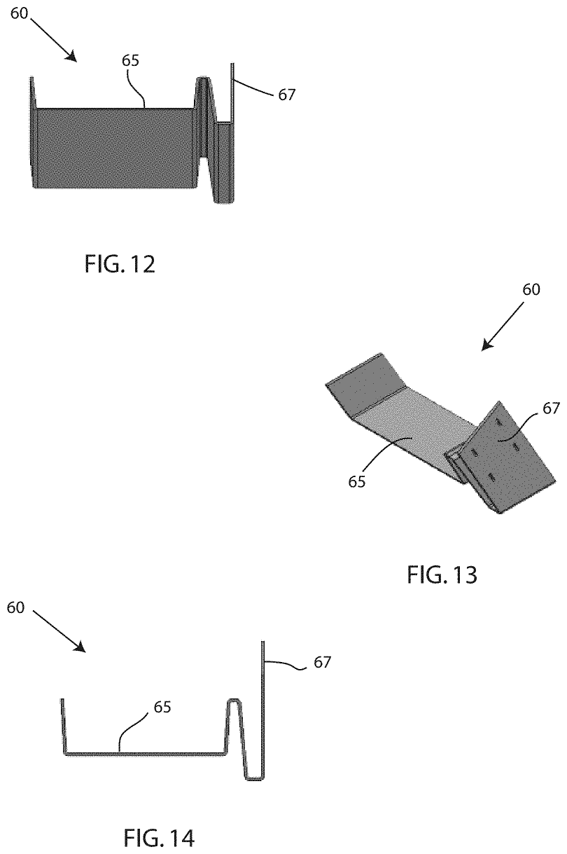

Referring now to FIGS. 12-14, embodiments of the container 100 may be connected to a sloped structure using one or more mounting elements 60. Embodiments of the mounting element 60 may be a mount, a bracket, an attachment mechanism, and the like, configured to removable secure, attach, or otherwise affix the container 100 to a sloped structure. Embodiments of the mounting element 60 may have a support surface 65 and a securing portion 67. The support surface 65 may be a flat surface that accommodates, receives, supports, engages, etc. with an exterior bottom surface 15 of the container 100 (shown in FIG. 5). Embodiments of the securing portion 67 may engage with a surface or section of the sloped surface for fastening the mounting element 60 to the sloped structure, which as a result supports and connects the container 100 to the sloped structure.

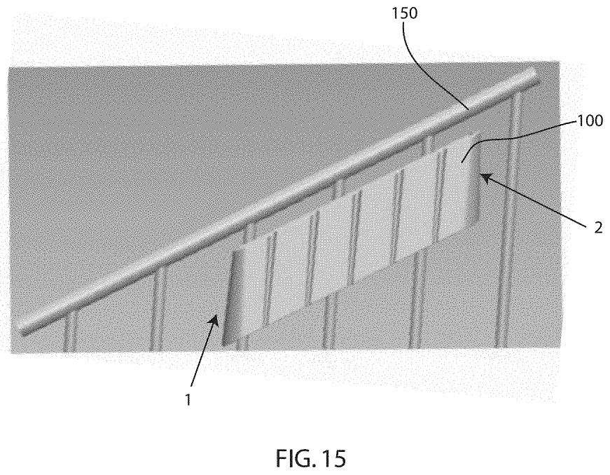

FIG. 15 depicts a view of the container 100 mounted to a sloped structure 150, in accordance with embodiments of the present invention. While mounted to the sloped structure 150, such as a stair handrail, the container 100 may be ramped, such that the first end 1 of the container 1 is at a lower elevation than the second end 2. However, because of the ramped inserts 50, a flat surface for placing contents within the container 100 may be level or flat with respect to a ground surface.

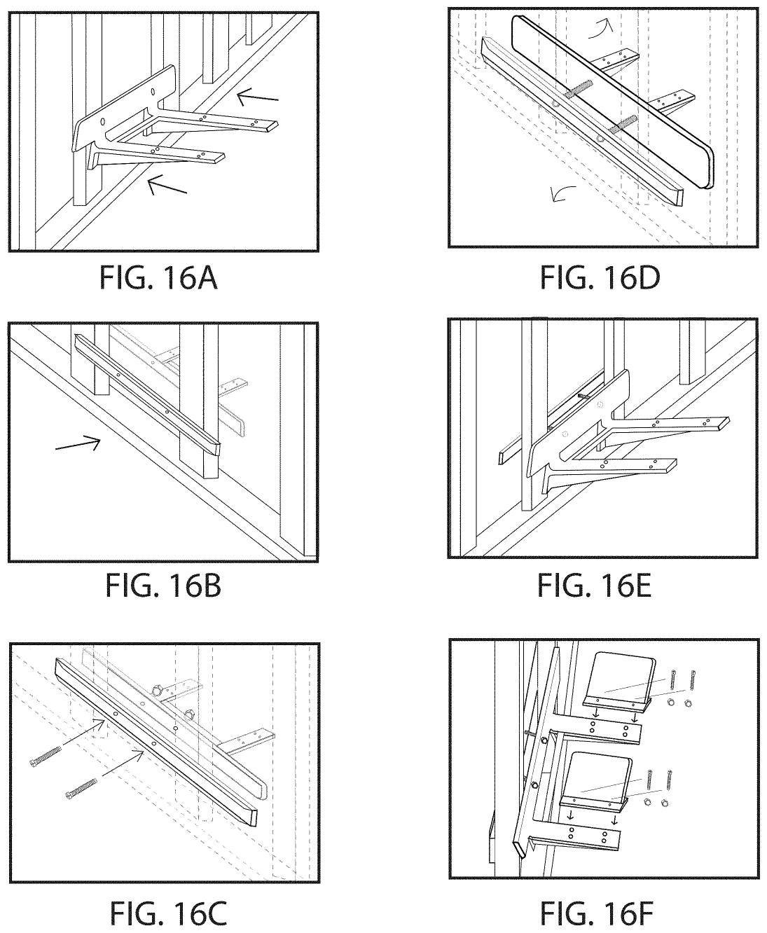

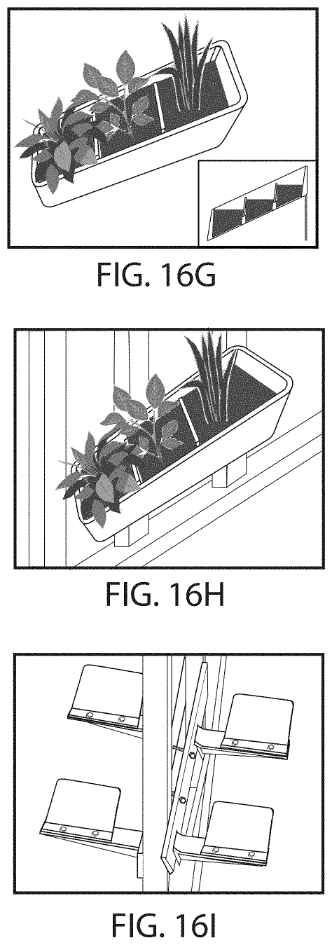

FIGS. 16a-16i depict another manner in which the container 100 can be mounted to a sloped structure, such as stairs, railings, balcony, etc, or any structure having railings or spindles. In a first installation step, arms are placed on the side of the stairs that the user desires to have the container 100 mounted. The single flat base of the arms is pressed against the railings of the stairs. In a second installation step, a stabilizer bar is placed on the opposite side of the railing with the flat side of the stabilizer bar pressed against or at least facing the railing. In a third installation step, fasteners, such as screws, are placed through the stabilizer bar and into the arms. Couplers (e.g. nuts) are then tightened enough to prevent the unit from sliding down the railing. In a fourth installation steps, the arms and/or stabilizer bar are adjusted to match the incline of the handrail or footrail of the railing, and the unit is slide to desired height. In a fifth installation step, the fasteners and couplers are tightened until there is no movement of the unit. In a sixth installation step, one or more hands are placed on the arms, making sure that the hands are pointed toward upstairs. Insert fasteners and couplers as shown, and tighten. In a seventh installation step, soil and/or desired flowers/plants are optionally placed in each pod of the container 100. In an eighth installation step, the container 100 is placed on the assembled unit (i.e. comprising the hands, stabilizer bar, and the arms. In an optional ninth installation step, two arms may be used (e.g. one on each side of the railing) to effect a double-sided installation on a single railing.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

The claims are as follows:

1. A mountable container comprising:
a body portion, defined by an exterior wall and a flat bottom surface;
at least one partition disposed within an interior of the body portion and being inclined with respect to the flat bottom surface, wherein the at least one partition divides the interior into a first interior region and a second interior region;
at least one insert disposed within the first interior region, the at least one insert having a ramped surface with respect to the flat bottom surface of the body portion within the first interior region;
wherein, when the body portion is mounted to a sloped structure at a slope corresponding to a slope of the sloped structure, the ramped surface of the at least one insert is flat with respect to a ground surface.

2. The mountable container of claim 1, further comprising an additional insert inserted into the second interior region.

3. The mountable container of claim 1, wherein the ramped surface of the at least one insert includes a plurality of openings.

4. The mountable container of claim 1, further comprising a mounting element to mount to the body portion to the sloped structure.

5. The mountable container of claim 1, further comprising flow channels extending between the at least one partition and the exterior wall to allow water to flow within the container.

6. The mountable container of claim 1, wherein the exterior wall includes a plurality of grooves, the plurality of grooves configured to receive structural elements of the sloped structure to enhance a connection between the body portion and the sloped structure.

7. The mountable container of claim 1, wherein the ramped surface of the at least one insert accommodates a plant material for displaying plants in a upright orientation, when the body portion is mounted to the sloped structure.

8. A method for maintaining a flat display surface within a sloped container, the method comprising:
disposing a ramped insert into an interior region of the sloped container.

9. The method of claim 8, wherein the sloped container includes at least one partition disposed within a general interior region of the body portion, wherein the at least one partition defines a first interior region and a second interior region.

10. The mountable container of claim 1, wherein the ramped surface slopes upwardly towards the at least one partition.
